(19) United States
(12) Patent Application Publication
(10) Pub. No.: US 2008/0250382 A1
(43) Pub. Date: Oct. 9, 2008

(54) SEMICONDUCTOR DEVICE MANUFACTURING METHOD

(76) Inventor: Masahiko KUMASHIRO, Osaka (JP)

Correspondence Address: MCDERMOTT WILL & EMERY LLP, 600 13TH STREET, NW, WASHINGTON, DC, 20005-3096, US

(21) Appl. No.: 12/062,922

(22) Filed: Apr. 4, 2008

(30) Foreign Application Priority Data
Apr. 4, 2007 (JP) 2007-098237

(51) Int. Cl. G06F 17/50

(52) U.S. Cl. 716/19

(57) ABSTRACT

A yielding percentage is calculated based on a first relationship, a probability distribution and a second relationship. The first relationship is a relationship between measurement values of a transfer pattern formed on a semiconductor substrate provided in the semiconductor device in the semiconductor lithographic process and number of sections on the semiconductor substrate where the measurement values are set. The probability distribution is a probability distribution showing variation of manufacturing parameters in the semiconductor lithographic process. The second relationship is a relationship between the manufacturing parameters and the measurement values.

### BACKGROUND OF THE INVENTION

1. Field of the Invention

The present invention relates to a method of manufacturing a semiconductor device, more particularly to a technology for calculating a yielding percentage variable due to connection failures (disconnection and short circuit) in wiring in the lithography for the semiconductor device.

2. Description of the Related Art

In the conventionally technology for designing a semiconductor, the layout of the semiconductor was formed in accordance with the regulations defined by design rules so that a desired yielding percentage could be surely obtained. An example of the technology is recited in No. 2006-337668 of the Japanese Patent Applications Laid-Open.

However, the photolithography has not yet been advanced enough to comply with increasingly integrated and miniaturized semiconductor integrated circuits available in recent years, and the resolution is relatively lower than expected, which makes it difficult to realize the patterning technology with a high accuracy. As a result, it is increasingly difficult to obtain a desired yielding percentage.

Whether or not an image-forming surface of a transfer layout pattern in the lithography can be accurately focused on a surface of a semiconductor substrate largely affects the clarity of a contour of the transfer layout pattern formed on the surface of the semiconductor substrate. The focus degree is expressed by a focus value, and the focus value and the clarity of the pattern are closely related to each other. The transfer layout pattern is accurately image-formed on the surface of the semiconductor substrate when the focus value is zero, while the contour of the transfer layout pattern is more unclear and blurred the more the focus value is larger than zero. The blur of the contour results in the generation of such failures as disconnection and short circuit in the transfer layout pattern.

The focus value at zero denotes an ideal state. The focus value, which cannot be always zero, is inevitably variable in a manufacturing process. As a result, in the layout which strictly observes the design rules in an initial stage where the process is developed, a degree of accuracy in the patterning is largely variable as the process development advances. The variable patterning accuracy invites the disconnection and short circuit and consequently deteriorates the yielding percentage of the semiconductor device.

In the case where a layout area needs to be reduced in a designing process, a patterning evaluation index at the time of the occurrence of disconnection and a patterning evaluation index at the time of the occurrence of the short circuit are related to each other in such a trade-off manner that a short circuit margin is insufficient when a disconnection margin is secured and the disconnection margin is insufficient when the short-circuit margin is secured. Then, it is not possible to determine such a layout that has optimal margins (disconnection and short-circuit margins) in view of the trade-off relationship. Therefore, the layout may be set in compliance with the design rules in the layout designing stage; however, it was conventionally difficult to manufacture the semiconductor device at a high yield rate using the layout thus designed.

### SUMMARY OF THE INVENTION

Therefore, a main object of the present invention is to provide a method of manufacturing a semiconductor device capable of improving performance and a yielding percentage thereof.

In order to achieve the foregoing object, a method of manufacturing a semiconductor device according to the present invention is a method of manufacturing a semiconductor device including the calculation of a yielding percentage variable due to the connection failure in wiring in a semiconductor lithographic process, wherein
the yielding percentage is calculated based on a first relationship, a probability distribution and a second relationship,
the first relationship is a relationship between measurement values of a transfer pattern formed on a semiconductor substrate provided in the semiconductor device in the semiconductor lithographic process and number of sections on the semiconductor substrate where the measurement values are set,
the probability distribution is a probability distribution showing variation of manufacturing parameters in the semiconductor lithographic process, and
the second relationship is a relationship between the manufacturing parameters and the measurement values.

In the present invention, the yielding percentage is calculated limitedly in the section thus selected in a reasonable manner as the target of the calculation of the yielding percentage. As a result, the trade-off relationship between the patterning margins can be optimized while an amount of time necessary for the calculation of the yielding percentage is controlled at the same time.

In the present invention, a function representing a relationship between the manufacturing parameters and the measurement values is preferably further calculated. The method of manufacturing the semiconductor device according to the present invention preferably further includes:
a step of setting a layout of the semiconductor device on the semiconductor substrate and then simulating the transfer pattern based on the set layout; and
a step of measuring the simulated transfer pattern and detecting a section of the transfer pattern where a pattern width is narrower than a certain width previously set, wherein
the yielding percentage is calculated based on the function representing the relationship between the manufacturing parameters and the measurement values and the probability distribution showing the variation of the manufacturing parameters.

Further, the probability distribution is preferably expressed by a normal distribution.

According to the foregoing constitutions wherein the function which expresses the relationship between the measurement values and the manufacturing parameters (focus value and the like) is generated, the correlation between the measurement values and the manufacturing parameters (focus value and the like) in relation to the measurement values can be efficiently figured out. Therefore, the variability distribution of the manufacturing parameters can be efficiently calculated from the manufacturing parameters (focus value and the like). As a result, the yielding percentage can be speedily calculated. When the variability distribution of the manufacturing parameters is expressed by the normal distribution, the yielding percentage can be more efficiently calculated.

Examples of the manufacturing parameters in the semiconductor lithographic process which affect the patterning margins include a focus value in the semiconductor lithographic process, an exposure value, a mask alignment shift value and the like. When the mask alignment shift value is set as the manufacturing parameter, the function is a function representing a relationship between an area where a wiring pattern on the semiconductor substrate and contact holes on the semiconductor substrate overlap with each other and the mask alignment shift value. Among the values, the focus value is favorably used as the manufacturing parameter, a reason for which is given below. A distance between the surface of the semiconductor substrate and an image-forming surface of the transfer layout pattern largely relates to the focus value in the semiconductor lithographic process. Therefore, when the focus value is used as the manufacturing parameter and the function which expresses the relationship between the measurement values and the focus value is used as the function, the calculation of the yielding percentage made to optimize the trade-off relationship between the patterning margins can be more effective. This is the reason why the focus value is favorable as the manufacturing parameter.

In the present invention, the probability distribution of the focus value and the probability distribution of the exposure value are both preferably regarded as equal within a certain distance range from the detected section. This is based on the fact that the focus in the semiconductor lithographic process and the exposure value are variable due to the same factor in the sections close to each other in the layout of the semiconductor integrated circuit. Therefore, the number of the distribution calculations in the detected section, which allows the yielding percentage to be more speedily calculated.

In the present invention, the yielding percentage is preferably calculated for a part of cells in the semiconductor device. Then, the calculation result of the yielding percentage of the part of cells is applied to a group of similar cells. As a result, the yielding percentage can be more efficiently calculated.

In the present invention, the certain width is preferably set to a value smaller than a pattern width used to judge a wiring connection failure in the layout. Accordingly, the yielding percentage can be more efficiently calculated.

In the present invention, the same function is preferably set in the layouts having an equal shape. As a result, the efficiency in the calculation of the yielding percentage can be improved.

It is preferable that a plurality of layouts be generated with respect to the semiconductor substrate, the yielding percentage be calculated in each of the plurality of layouts, and an optimum layout be selected based on comparison of the calculated yielding percentages. Accordingly, the trade-off relationship between the patterning margins can be optimized while the amount of time necessary for the calculation of the yielding percentage is prevented from increasing at the same time. As a result, such a layout that can obtain a high yielding percentage can be formed.

The method of manufacturing the semiconductor device according to the present invention preferably further includes a step of calculating a yielding percentage resulting from a failure generated with a certain probability in a manufacturing process.

According to the present invention thus described, the sections for which the yielding percentage is to be calculated are narrowed down based on the wiring connection failure judgment value in relation to the measurement values, and the yielding percentage in the selected section is calculated in the relationship between the measurement values and the manufacturing parameters. Therefore, the trade-off relationship between the patterning margins can be optimized while the amount of time necessary for the calculation of the yielding percentage is prevented from increasing at the same time. As a result, the variations in characteristics and dimensions due to the layout variability of the circuit pattern can be controlled, and the performance and yielding percentage can be improved.

### BRIEF DESCRIPTION OF THE DRAWINGS

These and other objects as well as advantages of the invention will become clear by the following description of preferred embodiments of the invention and be specified in the claims attached hereto. A number of benefits not recited in this specification will come to the attention of the skilled in the art upon the implementation of the present invention.

FIG. 1 is a conceptual view illustrating a method of manufacturing a semiconductor device according to a preferred embodiment of the present invention.

FIG. 2 shows an example of a section for which a yielding percentage is to be calculated according to the preferred embodiment.

FIG. 3 shows a transfer image measured values curve and a probability distribution curve of a focus value as a parameter.

FIG. 4 shows a transfer image measured values curve and a probability distribution curve of an exposure value as a parameter.

FIG. 5 shows a transfer image measured values curve and a probability distribution curve of mask alignment shift value as a parameter.

### DETAILED DESCRIPTION OF THE INVENTION

Hereinafter, a preferred embodiment of the present invention is described referring to the drawings.

### Preferred Embodiment

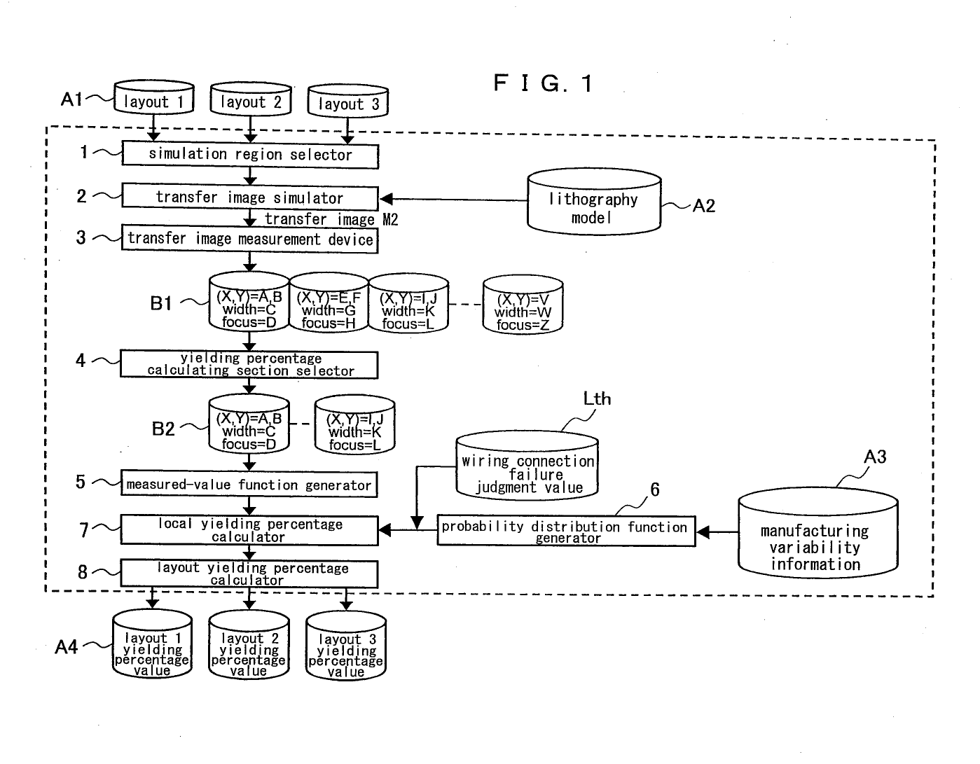

Below is described in detail a method of manufacturing a semiconductor device according to a preferred embodiment of the present invention referring to the drawings. FIG. 1 is a conceptual view illustrating the method of manufacturing the semiconductor device according to the preferred embodiment. Referring to reference numerals shown in FIG. 1, 1 denotes a simulation region selector, 2 denotes a transfer image simulator, 3 denotes a transfer image measurement device, 4 denotes a yielding percentage calculating section selector, denotes a measured-value function generator, 6 denotes a probability distribution function generator, 7 denotes a local yielding percentage calculator, and 8 denotes a layout yielding percentage calculator. The simulation region selector 1 narrows down sections targeted for the implementation of the transfer image simulation based on layouts A1 of a semiconductor integrated circuit supplied from database or the like. The transfer image simulator 2 generates a transfer image M2 using the simulator based on the layouts A1 of the semiconductor integrated circuit supplied from database or the like, an optical model of the lithography and a resist model A2 of the lithography. The transfer image measurement device 3 measures a width and a space of the generated transfer image M2 to thereby extract a disconnection margin insufficient section P1 having a smaller width and a short circuit margin insufficient section P2 having a smaller space, and then, outputs the extracted sections as an measured-value information B1. The yielding percentage calculating section selector 4 selects in order the sections in which the measured values are smaller and therefore the risk of the disconnection or short circuit is higher from the measured-value information B1 in order to narrow down the sections for which the yielding percentage is to be calculated. The measured-value function generator 5 generates a measured-value function F1 which expresses a relationship between the measurement values and a focus value. The probability distribution function generator 6 generates a probability distribution function F2 which expresses a variability level of the focus value. The local yielding percentage calculator 7 calculates a local yielding percentage Y_{L} based on the measured-value function F1, the probability distribution function F2 and a wiring connection failure judgment value Lth in relation to the measured values. The layout yielding percentage calculator 8 calculates a yielding percentage Y of all the layouts based on the local yielding percentage Y_{L}.

The operation of the method of manufacturing the semiconductor device according to the preferred embodiment thus constituted is described below.

Step S1: Narrowing-down of Sections to be Simulated

First, the simulation region selector 1 retrieves the layouts A1 of the semiconductor integrated circuit from the database or the like. The simulation region selector 1 selects the section to be subjected to the transfer image simulation of next Step S2 from the layouts A1. If all of the layouts are simulated, the yielding percentage can be accurately calculated, which, however, significantly increases an amount of time required for the simulation. Therefore, the simulation region selector 1 simulates one cell only one time concerning the same cells provided in a semiconductor chip, and applies the simulation result to all of the same cells. Accordingly, the simulation time can be reduced. Further, a layout having a large layout pattern and a large space in which the risk of the disconnection or short circuit is low is removed from transfer simulation objects in advance. Then, the simulation time can be reduced. Referring to layouts having the same shape, one of the layouts is simulated, and the simulation result is applied to the other layout having the same shape. As a result, the simulation time can be reduced.

Steps S2: Generation of Transfer Image

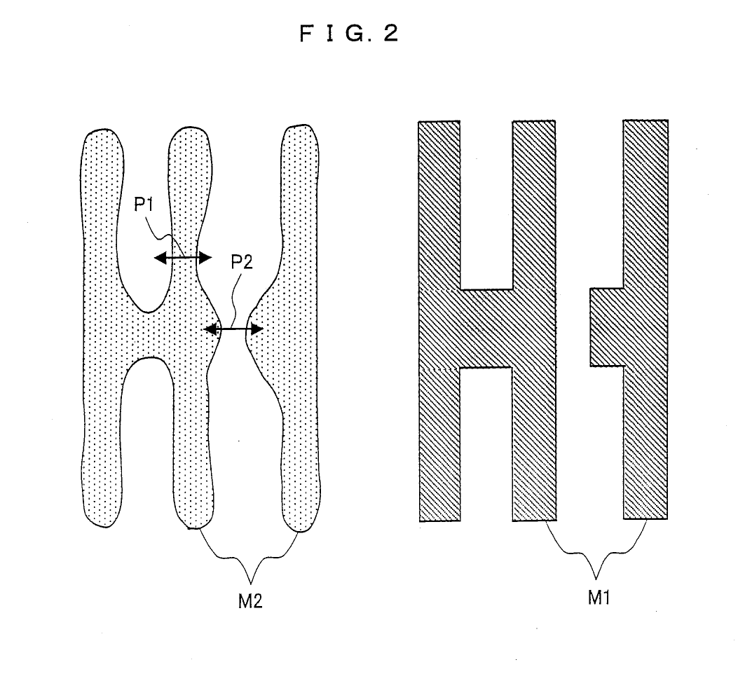

Subsequent to Step S1, the transfer image simulator 2 retrieves the layouts A1 and the lithography model A2 of the semiconductor integrated circuit from the database or the like. The transfer image simulator 2 generates a transfer image M2 using the simulator based on these inputted data. More specifically, the transfer image M2 is generated from the optical model of the lithography and resist model M1 as shown in FIG. 2.

In order to accurately calculate the yielding percentage, it is desirable that conditions for the simulation be changed for each of manufacturing parameters in the lithography (for example, focus value, exposure value and mask alignment shift value), and a large number of transfer images be generated. As the number of the simulation conditions is larger, the accuracy of the yielding percentage is increased, but the number of the calculations is also increased.

Step S3: Measurement→Extraction of Margin-insufficient Section (first stage where yielding percentage calculating sections are narrowed down)

Subsequent to Step S2, the transfer image measurement device 3 measures the wiring width and space between the adjacent wiring in the transfer image M2 (generated by the transfer image simulator 2), and extracts the disconnection margin insufficient section P1 having a smaller width and a short-circuit margin insufficient section P2 having a smaller space between the adjacent wiring in the transfer image M2. The transfer image measurement device 3 outputs the measured-value informations B1 in the extracted disconnection margin insufficient section P1 and short-circuit margin insufficient section P2. The measured-value information B1 includes measurement coordinates, measured value of the width or space and manufacturing parameters. Step S3 is thus the first stage where the yielding percentage calculating sections are narrowed down.

Step S4: Ranking of Margin-insufficient Section (second stage where yielding percentage calculating sections are narrowed down)

Subsequent to Step S3, the yielding percentage calculating section selector 4 selects the information relating to the sections where the measured values are small (where the risk of the disconnection or short circuit is higher) from the measured-value information B1 in increasing order of the measured values. In the selection, the accuracy of the calculated yielding percentage is increased as the amount of the information to be selected is larger; however, the number of the calculations is unfavorably increased. Therefore, the information of the sections which largely affect the yielding percentage calculation result is prioritized. More specifically, a plurality of measured values of measured-value information B1 are compared to a predetermined measured value threshold Wth, and the measured-value information B1 in which the measured values are smaller than the predetermined measured value threshold Wth as a result of the comparison is extracted. Further, the extracted measured-value informations B1 are ranked so that smaller measured values are more prioritized, and the measured-value information B1 extracted in accordance with the ranking is outputted as measured-value information B2 of which the measured values are below the measured value threshold Wth. The measured-value information of which the measured value are equal to or more than the measured value threshold Wth is ignored because the yielding percentage calculated from the information only generates such a small influence as a minor error. Thus, Step S4 is the second stage where yielding percentage calculating sections are narrowed down. As a result of the implementation of Step S4, the calculation result can achieve such a high accuracy that an obtained yielding percentage approximates to an actual yielding percentage.

The following steps are described referring to the focus value as an example of the manufacturing parameters.

Step S5: Generation of Measured-value Function f (F1)

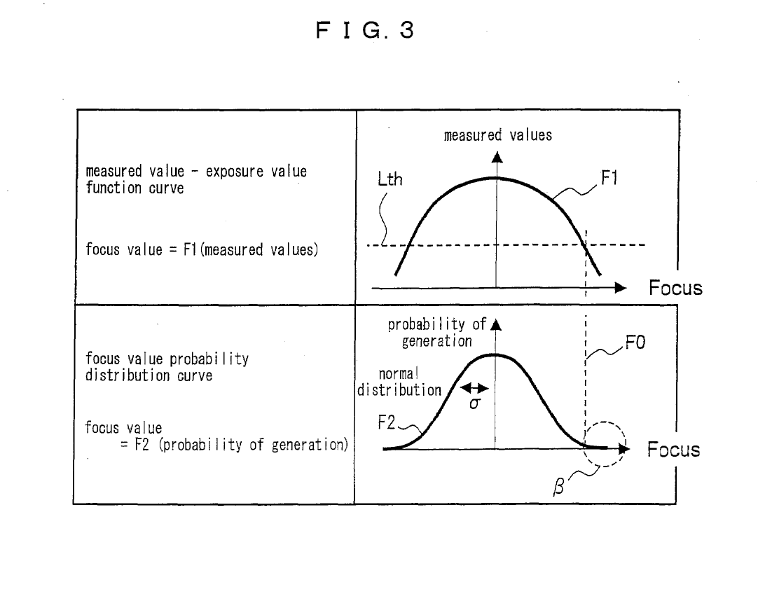

As a result of the implementation of Step S4, a plurality pieces of measured-value information B2 can be obtained in relation to one measuring section P1. In Step S5, the measured-value function generator 5 extracts all pieces of measured-value information in which the focus value is different from each other from the plurality pieces of measured-value information B2 relating to one measuring section P1. The extracted measured-value information denotes a relationship between the focus value and the measured values of the transfer image in relation to one measuring section P1 in the layout of the semiconductor integrated circuit. The relationship is expressed by the measured-value function F1 (see the upper section in FIG. 3).

focus value=F1 (measured values of transfer image) 1)

As the number of the focus conditions in the measuring section P1 in the extracted measured-value information B2 is larger, the measured-value function F1 becomes such a more highly accurate function that approximates to actually measured values. The measured-value function F1 is generated for all pieces of the measured-value information B2 selected in Step S4. As a result, a plurality of measured-value functions F1 can be obtained.

Step S6: Generation of Probability Distribution Function F2

The probability distribution function generator 6 fetches manufacturing variability information A3 actually measured in the lithography and memorizes it. Subsequent to Step S5, the distribution function generator 6 calculates the probability of obtaining the respective focus condition values based on the memorized manufacturing variability information A3 in Step S6. The probability distribution of the calculated focus values shows a curve expressed by the probability distribution function F2 (see lower column shown in FIG. 3) and each of the focus values can be expressed as follows.

focus value=F2 (probability of generation) 2)

When the same probability distribution function F2 is used in all of the measuring sections, an amount of time for calculating the probability distribution can be reduced. However, in measuring sections where the phenomenon in a manufacturing process (for example, lithography) is different, if the same probability distribution function F2 is applied to the calculation of the yielding percentage with no consideration given to such a difference, the calculation cannot achieve a high accuracy. Despite that, the focus in the lithography is considered to be variable due to the same factor in the adjacent measuring sections with a short distance therebetween in the layout of the semiconductor integrated circuit. Therefore, when the same probability distribution function F2 is applied to the calculation of the yielding percentage in the adjacent measuring sections, a favorable accuracy can be retained in the calculation of the yielding percentage. Accordingly, the same probability distribution function F2 is applied to the calculation of the yielding percentage in the adjacent measuring sections, while the different probability distribution functions F2 are applied to the calculation of the yielding percentage in the measuring sections distant from each other in place of the same probability distribution function F2. Then, the number of the probability distribution functions F2 to be generated in the respective measuring sections can be reduced. As a result, the yielding percentage can be more speedily calculated without the deterioration of the accuracy in the calculation of the yielding percentage.

Step S7: Calculation of Local Yielding Percentage

Subsequent to Step S6, the local yielding percentage calculator 7 calculates the yielding percentage of the layout of the semiconductor integrated circuit based on the measured-value function F1, probability distribution function F2 and wiring connection failure judgment value Lth in the region where the sections to be simulated were narrowed down in Step S1. Below is given a description.

First, the local yielding percentage calculator 7 calculates the yielding percentage of one measuring section selected from among the plurality of measuring sections P1 having the measured-value information B2. When the focus value is the same, the following relational expression is established from the measured-value function F1 and the probability distribution function F2.

F1 (measured value of transfer image)=F2 (probability of generation) 3)

Then, the following relational expression is assigned to the relational expression in 3), and by so doing, a probability β at which the disconnection or short circuit is generated in the measuring section P1 can be calculated from the probability distribution function F2.

F1 (measured value of transfer image)=Lth 4)

Lth=wiring connection failure judgment value

Next, the probability β is calculated in relation to all of the measuring sections P1 in the measured-value information B2 which were narrowed down and selected, based on the same calculation method as described earlier. As an example of the calculation of the probability β by approximating the probability distribution function F2 of the variability of the focus value by the normal distribution, provided that a standard deviation of the variability of the focus value is σ,

failure probability β=NORMDIST (F0, average, σ, TRUE) 5).

NORMDIST is a function of spreadsheet software, wherein a value of a cumulative distribution function of a standard normal distribution is returned to an average and a standard deviation.

When the failure probability β in each of the measuring sections P1 of the measured-value informations B2, which were selected after being narrowed down, is calculated and multiplied, the failure probabilities β in all of the simulation region selected after being narrowed down by the simulation region selector 1 can be calculated. Therefore, the local yielding percentage Y_{L} in the simulation region can be calculated as follows in the case where the generation of the failure is not allowed in any section.

local yielding percentage Y_{L}=(1−β₁)*(1−β₂)*(1−β₃)* 6)

Step S8: Calculation of Yielding Percentage in All the Layouts

Subsequent to the calculation of the local yielding percentage Y_{L} in Step S7, the layout yielding percentage calculator 8 calculates the yielding percentage Y of all the layouts using the local yielding percentage Y_{L}. The yielding percentage can be calculated in such a manner that all the layouts are simulated at the same time, which, however, significantly increases the simulation time. Therefore, when the local yielding percentage Y_{L} in the simulation range selected by the simulation region selector 1 is multiplied, the yielding percentage Y of all the layouts can be speedily calculated.

yielding percentage Y of all the layouts=Y_{L1}*Y_{L2}*Y_{L3}* 7)

As described, according to the present preferred embodiment, the objects for which the yielding percentage is to be calculated are narrowed down based on the wiring connection failure judgment value in relation to the measured values in the relationship between the measured values and the manufacturing parameters of the lithography, and the yielding percentage is calculated in the objects thus narrowed down. Therefore, the trade-off relationship between the patterning margins can be optimized while the increase of the amount of time necessary for the calculation of the yielding percentage is controlled at the same time.

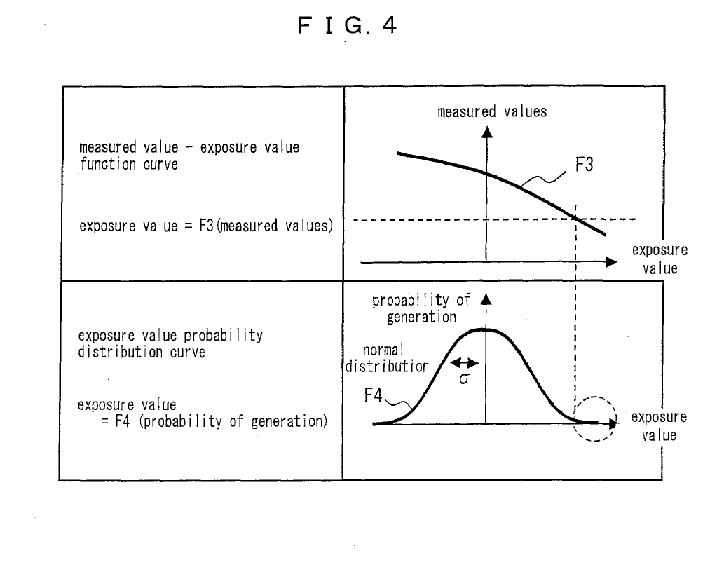

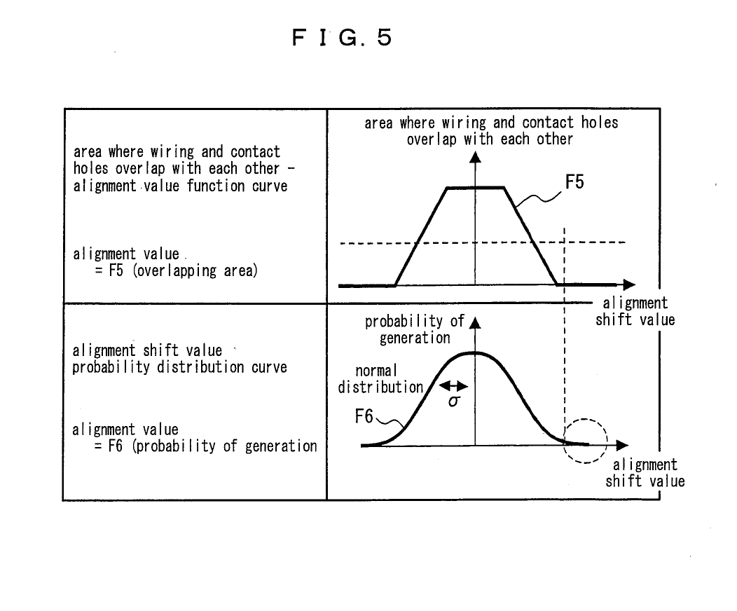

So far was described the calculation of the yielding percentage made when the focus value was variable in the manufacturing process. However, the variability of the exposure value and the variability of the mask alignment shift value in the lithography also largely influence the yielding percentage. In the case where the yielding percentage is calculated in relation to the variability of the exposure value and the variability of the mask alignment shift value, curves shown by respective functions, as shown by are measured-value functions F3 and F5 and probability distribution functions F4 and F6 in FIGS. 4 and 5, are varied depending on the manufacturing process in comparison to the focus value, but the local yielding percentage and the yielding percentage of all the layouts can be calculated thereafter just as in the case of the variability of the focus value.

When a layout having the same circuit configuration and a certain area is prepared in the designing process, a plurality of layouts, including a layout that secures the disconnection margin and a layout that secures the short circuit margin are prepared within the design rules, and the yielding percentage of an entire layout is calculated. Then, the layout in which the yielding percentage is maximized is selected.

Further, the yielding percentage due to the failure generated with a certain probability in the manufacturing process is calculated and multiplied by the yielding percentage of all the layouts due to the disconnection/short circuit in the lithography. By so doing, the yielding percentage of the semiconductor integrated circuit which a los takes into account random and systematic factors can be calculated. When the layout in which the yielding percentage is maximized is selected, the optimum layout which takes into account the trade-off relationship between the random and systematic failures can be formed.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A method of manufacturing a semiconductor device the calculation of a yielding percentage variable due to the connection failure in wiring in a semiconductor lithographic process , wherein
the yielding percentage is calculated based on a first relationship, a probability distribution and a second relationship,
the first relationship is a relationship between measurement values of a transfer pattern formed on a semiconductor substrate provided in the semiconductor device in the semiconductor lithographic process and number of sections on the semiconductor substrate where the measurement values are set,
the probability distribution is a probability distribution showing variation of manufacturing parameters in the semiconductor lithographic process, and
the second relationship is a relationship between the manufacturing parameters and the measurement values.

2. The method of manufacturing the semiconductor device as claimed in claim 1, wherein
a function representing a relationship between the manufacturing parameters and the measurement values is further calculated.

3. The method of manufacturing the semiconductor device as claimed in claim 1, further including:
a step of setting a layout of the semiconductor device on the semiconductor substrate and then simulating the transfer pattern based on the set layout; and
a step of measuring the simulated transfer pattern and detecting a section of the transfer pattern where a pattern width is narrower than a certain width previously set, wherein
the yielding percentage is calculated based on the function representing the relationship between the manufacturing parameters and the measurement values and the probability distribution showing the variation of the manufacturing parameters.

4. The method of manufacturing the semiconductor device as claimed in claim 1, wherein
the variability distribution is expressed by a normal distribution.

5. The method of manufacturing the semiconductor device as claimed in claim 3, wherein
a focus value in the semiconductor lithographic process is used as the manufacturing parameter, and the function is a function representing a relationship between the focus value and the measurement values.

6. The method of manufacturing the semiconductor device as claimed in claim 3, wherein
an exposure value in the semiconductor lithographic process is used as the manufacturing parameter, and the function is a function representing a relationship between the exposure value and the measurement values.

7. The method of manufacturing the semiconductor device as claimed in claim 2, wherein
a mask alignment value in the semiconductor lithographic process is used as the manufacturing parameter, and the function is a function representing a relationship between an area where a wiring pattern on the semiconductor substrate and contact holes on the semiconductor substrate overlap with each other and the mask alignment shift value.

8. The method of manufacturing the semiconductor device as claimed in claim 5, wherein
the probability distribution of the focus value is regarded as equal within a certain distance range from the detected section.

9 . The method of manufacturing the semiconductor device as claimed in claim 6, wherein
the probability distribution of the exposure value is regarded as equal within a certain distance range from the detected section.

10. The method of manufacturing the semiconductor device as claimed in claim 1, wherein
the yielding percentage is calculated f or a part of cells in the semiconductor device.

11. The method of manufacturing the semiconductor device as claimed in claim 3, wherein
the certain width is set to a value smaller than a pattern width used to judge a wiring connection failure in the layout.

12. The method of manufacturing the semiconductor device as claimed in claim 3, wherein
the same function is set in the layouts having an equal shape.

13. The method of manufacturing the semiconductor device as claimed in claim 3, wherein
a plurality of layouts are generated with respect to the semiconductor integrated circuit, the yielding percentage is calculated in each of the plurality of layouts, and an optimum layout is selected based on comparison of the calculated yielding percentages.

14. The method of manufacturing the semiconductor device as claimed in claim 3, further including a step of calculating the yielding percentage resulting from a failure generated with a certain probability in a manufacturing process.
